(19) United States
(12) Patent Application Publication
(10) Pub. No.: US 2018/0279764 A1
(43) Pub. Date: Oct. 4, 2018

(54) COMBINATION TOOTHBRUSH AND DENTAL FLOSS DISPENSER

(71) Applicant: Gerald Hill, Rockport, ME (US)

(72) Inventor: Gerald Hill, Rockport, ME (US)

(21) Appl. No.: 15/473,389

(22) Filed: Mar. 29, 2017

(51) Int. Cl. A46B 15/00; A61C 15/04; A46B 9/04

(52) U.S. Cl. CPC A46B 15/0073; A46B 2200/1066; A46B 9/04; A61C 15/043

(57) ABSTRACT

A dental hygiene device includes a toothbrush and a dental floss dispenser. The dental floss is stored in the handle of the dental hygiene device and is wound without a spool to decrease the diameter of the handle and allow the handle to fit within a conventional toothbrush holder. The dental hygiene device can also be used to aid in flossing, eliminating the need to use insert two fingers into a user's mouth in order to floss. After flossing, the floss can be severed by using a floss cutter disposed on the handle of the device.

### BACKGROUND OF THE INVENTION

### 1. Field of the Invention

The present invention generally relates to an oral hygiene device. More specifically, the present invention relates to a device that combines the function of a toothbrush with a dental floss dispenser.

### 2. Background Art

Devices combining a toothbrush with a dental floss dispenser are generally known. For example, U.S. Pat. Nos. 7,201,172 and 7,237,560 and U.S. Pat. App. 2003/0188761 disclose toothbrushes that include a supply of dental floss within the handle, an orifice through which a user can pull the floss, and a cutter to cut a length of floss. When using these devices, a user pulls a length of floss through the orifice, cuts the floss at the desired length, and proceeds to use the floss in a conventional manner by winding each end of the floss around a finger before flossing.

U.S. Pat. App. No. 2009/0188519 discloses a toothbrush that includes a supply of dental floss within the handle, an orifice through which a user can pull the floss, a flossing device, and a cutter. To use the device, a user first pulls the floss through the orifice and threads it through the flossing device. The user then flosses his teeth using the flossing device and after flossing, the user pulls an additional amount of floss to remove the used portion of floss, thus priming the device for the next use.

The references described above, while functional, present practical problems that must be overcome. First, because earlier designs include spools around which the floss is wound, the handles of the devices are larger than a typical toothbrush, thus the size of the handle prevents a user from storing those devices in a conventional toothbrush holder. Second, previous designs do not allow the user to view how much floss is in the handle, leaving the user to guess when the floss will run out. Third, a significant issue with flossing is the difficulty of maneuvering the floss within the mouth when the floss is wrapped around a user's finger on either end. None of the prior devices provides a way to minimize the space utilized within a user's mouth while still providing the flexibility of using one's own finger.

There exists a need for a device that combines a toothbrush with a dental floss dispenser, while providing for a more comfortable and convenient flossing experience.

### SUMMARY OF THE INVENTION

Accordingly, there is provided herein a dental hygiene device comprising a brush head portion with a proximal brush head end and a distal brush head end, the distal brush head end including bristles. A floss dispenser portion includes a proximal floss dispenser end and a distal floss dispenser end, and the distal floss dispenser end is releasably connected to the proximal brush head end. The floss dispenser portion includes a hollow section in which a wound coil of floss is disposed, the hollow section extending the entire length of the floss dispenser portion. An end cap portion is releasably attached to the proximal floss dispenser end and covers the hollow section. The end cap portion includes a circumferential groove and a longitudinal groove, both grooves extending at least partially through the outer diameter of the end cap portion and providing surfaces around which dental floss may be secured. The end cap portion also includes an aperture that extends through the proximal end of the end cap portion and is in communication with the hollow section in the floss dispenser portion.

Additionally, there is provided herein a method of providing oral care comprising providing the dental hygiene device described above, then pulling a floss payout end of the wound coil of floss until enough floss is exposed to permit a user to floss his teeth, the floss payout end extending through the aperture. The method continues by securing the floss through the longitudinal and circumferential grooves to create a secured length of floss, and pulling the floss payout end to create tension in the secured length of floss. The method concludes by inserting the secured length of floss between two teeth to clean a space between the two teeth.

### BRIEF DESCRIPTION OF THE DRAWINGS

The present invention will now be discussed in further detail below with reference to the accompanying figures in which:

FIG. 1 illustrates an assembled view of a dental hygiene device according to the present invention;

FIG. 2 illustrates an exploded view of the dental hygiene device shown in FIG. 1;

FIG. 3 illustrates a cross-sectional, side elevation of a floss dispenser portion of the dental hygiene device shown in FIG. 1;

FIGS. 4-7 illustrate the method by which a wound coil of floss is created, shown in successive steps;

FIG. 8 illustrates a method of use of the dental hygiene device shown in Fig.1;

FIG. 9 illustrates a bottom elevation of an end cap portion of the dental hygiene device shown in FIG. 1;

FIG. 10 illustrates an exploded view of a second embodiment of the dental hygiene device;

FIG. 11 illustrates a second embodiment of the floss dispenser portion of the dental hygiene device;

FIG. 12 illustrates an exploded view of a third embodiment of the dental hygiene device;

FIG. 13 illustrates an assembled view of a fourth embodiment of the dental hygiene device; and

FIG. 14 illustrates a cross-sectional view of a second embodiment of the end cap portion.

### DETAILED DESCRIPTION OF THE PREFERRED EMBODIMENTS

Throughout the description, a user is referenced as a male by using the pronouns “he” or “his”. Use of male pronouns to describe a user is for convenience only, and the user can be either male or female.

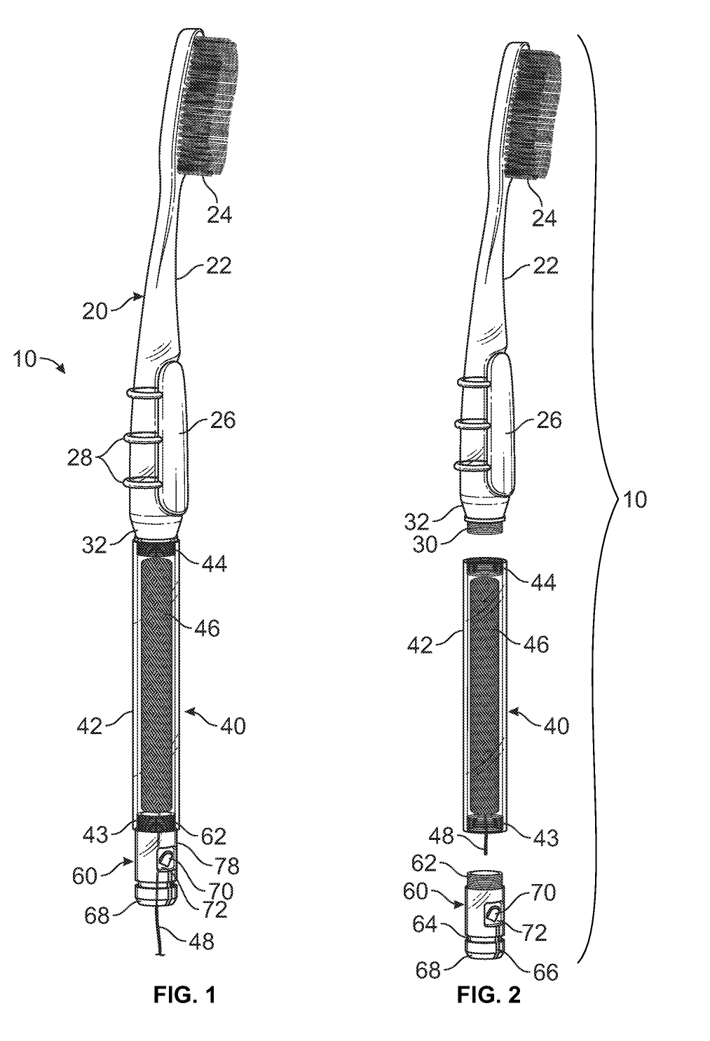

Referring now to FIGS. 1 and 2, in which the inventive device is shown in assembled and exploded views, respectively, a dental hygiene device 10 includes a brush head portion 20, a floss dispenser portion 40, and an end cap portion 60. Brush head portion 20 further includes a longitudinal extension 22, a brush head 24, a frictional grip protrusion 26, a protrusion securing band 28, a threaded male connection 30, and a beveled end 32. Floss dispenser portion 40 further includes a longitudinal container wall 42, a threaded female connection 43, a threaded female connection 44, and a wound floss coil 46. End cap portion 60 further includes end cap male threads 62, a circumferential groove 64, a longitudinal groove 66, a beveled corner 68, a floss cutter 70, and an end cap recess 72.

Longitudinal extension 22 is an elongated member extending from beveled end 32 to brush head portion 24. Longitudinal extension 22 is generally manufactured from plastic, however other suitable materials may be used. Longitudinal extension 22 may be hollow to decrease weight and cost, but it may also be solid. The diameter of longitudinal extension 22 is larger near beveled end 32 and tapers down to a smaller diameter near brush head 24. The smaller diameter near brush head 24 allows for longitudinal extension 22 to be more flexible near brush head 24, such that when a user is brushing his teeth and putting pressure on his teeth with brush head 24, longitudinal extension 22 can flex in response to the force imparted by the user. Additionally, the smaller, tapered ends of brush head 24 permit easier insertion into, and manipulation within, the user's mouth.

Brush head 24 is the part of dental hygiene device 10 that is used to clean a user's teeth. Brush head 24 may include bristles to aid in cleaning teeth, and the bristles may be of any size, shape, and material conventionally used for cleaning teeth. Alternatively, brush head 24 may include other ways to clean teeth, including scrapers, ultrasonic cleaners, or water jets.

Frictional grip protrusion 26, disposed at an opposite end from brush head 24 on longitudinal extension 22, provides a user with a more secure grip when cleaning his teeth. Frictional grip protrusion 26 is typically easier to grip than longitudinal extension 22, especially when wet, and it may be made from rubber, silicone, or any other material that may provide a better gripping surface than the material of longitudinal extension 22.

Protrusion securing band 28 may be one or more bands used to secure frictional grip protrusion 26 to longitudinal extension 22. In one embodiment, protrusion securing band 28 and frictional grip protrusion 26 are one piece, and they are disposed on longitudinal extension 22 by a single molding or connecting process. In another embodiment, protrusion securing band 28 and frictional grip protrusion 26 are separate pieces, and they may be disposed on longitudinal extension by different molding or connecting processes. For example, frictional grip protrusion 26 may be injection molded onto longitudinal extension 22 in one molding process, and then frictional grip protrusion 28 may be injection molded onto longitudinal extension 22 in a second molding process. In one embodiment, protrusion securing band 28 and frictional grip protrusion 26 are the same material. In another embodiment, protrusion securing band 28 and frictional grip protrusion 26 are different materials.

Beveled end 32 provides a transition from longitudinal extension 22 to male threads 30. In one embodiment, beveled end 32 provides a gradual transition at a shallow angle, between 0 and 45 degrees. In another embodiment beveled end 32 provides a sudden transition at a steep angle, between 45 and 90 degrees.

Male threads 30 are disposed on the proximal end of brush head portion 20 and communicate with female threads 44 to connect brush head portion 20 to floss dispenser portion 40. Male threads 30 may be single start, double start, triple start, or any other design that provides for easy connection and disconnection when needed. The pitch of male threads 30 may be any pitch that allows connection of brush head portion 20 and floss dispenser portion 30, and the shape of male threads 30 may be any conventional shape that provides for a secure connection, like square, triangular, trapezoidal, or other shapes.

Female threads 44 are disposed on the distal end of floss dispenser portion 40 and may be single start, double, start, triple start, or any other design that mates with male threads 30 to provide a secure, threaded connection. The pitch of female threads 44 and the shape of female threads 44 must also match those of male threads 30 to provide a secure, threaded connection. While male threads 30 are shown on brush head portion 20 and female threads 44 are shown on floss dispenser portion 40, they may be interchangeable with each other such that male threads 30 may be disposed on floss dispenser portion 40 and female threads 44 may be disposed on brush head portion 20.

Floss dispenser portion 40 is an elongated, hollow section that detachably connects to brush head portion 20 and end cap portion 60. Floss dispenser portion 40 may be manufactured from a substantially rigid material, including plastic or composite materials.

Floss dispenser portion 40 may flex slightly during use, however any flexing is generally imperceptible to the user using dental hygiene device 10. The outer diameter of floss dispenser portion 40 is small enough such that floss dispenser portion 40 fits through the hole of a conventional toothbrush holder.

Wound coil of floss 46 is housed within longitudinal container 20. Wound coil of floss 46 may be any type of conventional dental floss like waxed, unwaxed, flavored, or unflavored, and it may be any cross-sectional shape like round, flat, square, or any other conventional dental floss shape. Floss payout end 48 is the end of wound coil of floss 46 that extends through an aperture in end cap 60 such that the user can pull floss payout end 48 to properly use dental hygiene device 10.

Longitudinal container wall 42 provides the user the ability to determine how much floss is left in wound coil of floss 46. Longitudinal container wall 42 also provides the user with a visual stimulus to remind the user to floss by allowing the user to view wound coil of floss 46 through longitudinal container wall 42. To provide these functions, longitudinal container 42 wall is substantially clear, translucent, or transparent. In some embodiments, the user can see through the entirety of longitudinal container wall 42 to determine how much floss is left. In other embodiments, only a portion of longitudinal container wall 42 is substantially clear, translucent, or transparent, and the user may only be able to see through a portion of longitudinal container wall 42 to view how much floss is left on wound coil of floss 46.

Container female threads 43 are disposed on the proximal end of floss dispenser portion 40 and communicate with end cap male threads 62 to connect floss dispenser portion 40 to end cap portion 60. Container female threads 43 may be single start, double start, triple start, or any other design that provides for easy connection and disconnection when needed. The pitch of container female threads 43 may be any pitch that allows connection of floss dispenser portion 40 and end cap portion 60, and the shape of container female threads 43 may be any conventional shape that provides for a secure connection, like square, triangular, trapezoidal, or other shapes.

End cap male threads 62 are disposed on the distal end of end cap portion 60 and may be single start, double, start, triple start, or any other design that mates with container female threads 43 to provide a secure, threaded connection. The pitch of end cap male threads 62 and the shape of end cap male threads 62 must also match those of container female threads 43 to provide a secure, threaded connection. While end cap male threads 62 are shown on end cap portion 60 and container female threads 43 are shown on floss dispenser portion 40, they may be interchangeable with each other such that end cap male threads 62 may be disposed on floss dispenser portion 40 and container female threads 43 may be disposed on end cap portion 60.

End cap portion 60 is an elongated, hollow section that detachably connects to floss dispenser portion 40. End cap portion 60 may be manufactured from a substantially rigid material, including plastic or composite materials. End cap portion 60 may flex slightly during use, however any flexing is generally imperceptible to the user using dental hygiene device 10. The outer diameter of end cap portion 60 is small enough such that end cap portion 60 fits through the hole of a conventional toothbrush holder, and does not present much difficulty in insertion thereof into a user's mouth.

Floss cutter 70 is housed within end cap recess 72 of end cap portion 60. Floss cutter 70 may be a conventional type of floss cutter that would normally be found on a conventional container of dental floss. Floss cutter 70 is typically made from metal, however other rigid materials that could effectively sever a length of dental floss may be used. End cap recess 72 is a recess within end cap 60, and end cap recess 72 is deep enough such that the top of floss cutter 70 does not extend beyond the outer edge of end cap recess 72. This configuration reduces the risk of a user accidentally cutting himself on floss cutter 70 when using dental hygiene device 10 as described below.

Circumferential groove 64 and longitudinal groove 66 are recesses within end cap 60, and they are sized appropriately to receive one or more layers of dental floss wrapped around end cap portion 60. Beveled corner 68 is located at the proximal end of end cap 60, and it is beveled to reduce sharp corners for ease of manufacturing, and to provide an easier transition when a user is wrapping dental floss around end cap 60. Beveled corner 68 also provides a smooth surface to more easily insert end cap 60 into a user's mouth and remove end cap 60 from a user's mouth. The process of wrapping floss around end cap 60 will be further discussed with reference to FIGS. 8 and 9. While end cap portion 60 is shown with beveled corner 68, other configurations are possible such as a rounded, oval, or egg-shaped end having appropriate longitudinal and circumferential grooves.

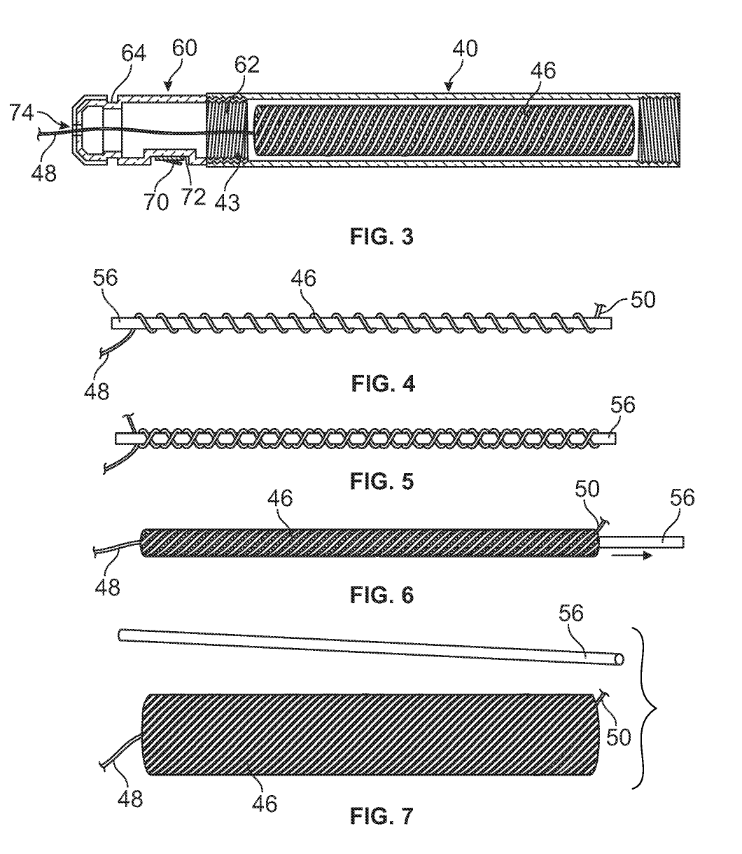

Referring to FIG. 3, a cross-section of floss dispenser portion 40 and end cap portion 60 is shown. End cap portion 60 further includes end cap aperture 74. End cap aperture 74 is an opening that extends through the proximal end of end cap portion 60, and it is sized such that the diameter of end cap aperture 74 is larger than the largest cross-sectional dimension of a piece of dental floss that may extend through end cap aperture 74. End cap aperture 74 may include a converging opening such that the opening is larger toward the distal end of end cap portion 60 and smaller toward the proximal end of end cap portion 60. Configured in this manner, dental floss will be effectively guided through end cap aperture 74 when it is inserted through end cap aperture 74 during the assembly process.

Referring now to FIGS. 1-3, the apparatus assembly process will be described. The dental hygiene device 10 is assembled by first placing wound coil of floss 46 within floss dispenser portion 40. The inner diameter of female threads 44 and container female threads 43 are sized such that the outer diameter of wound coil of floss 46 can pass through either of the inner diameters. Floss payout end 48 is then fed through end cap aperture 74 so floss payout end 48 is accessible outside of end cap portion 60. End cap portion 60 and floss dispenser portion 40 are then connected by mating container female threads 43 and end cap male threads 62. The inner diameter of male threads 62 is sized to be larger than the outer diameter of wound coil of floss 46 to prevent wound coil of floss 46 from entering end cap portion 60 and obscuring the view of wound coil of floss 46 through longitudinal container wall 42. Next, brush head portion 20 is connected to floss dispenser portion 40 by mating female threads 44 and male threads 30. The inner diameter of male threads 30 is sized to be larger than the outer diameter of wound coil of floss 46 to prevent wound coil of floss 46 from entering brush head portion 20.

Alternatively, the inventive dental hygiene device could be assembled by first connecting brush head portion 20 and floss dispenser portion 40 as described above, and then placing wound coil of floss 46 inside floss dispenser portion 40. Assembly would then continue as described above. The exact order of assembly steps is not of critical importance and it is within the skill of an ordinary person working in this industry to vary or change the order as long as all the steps are completed.

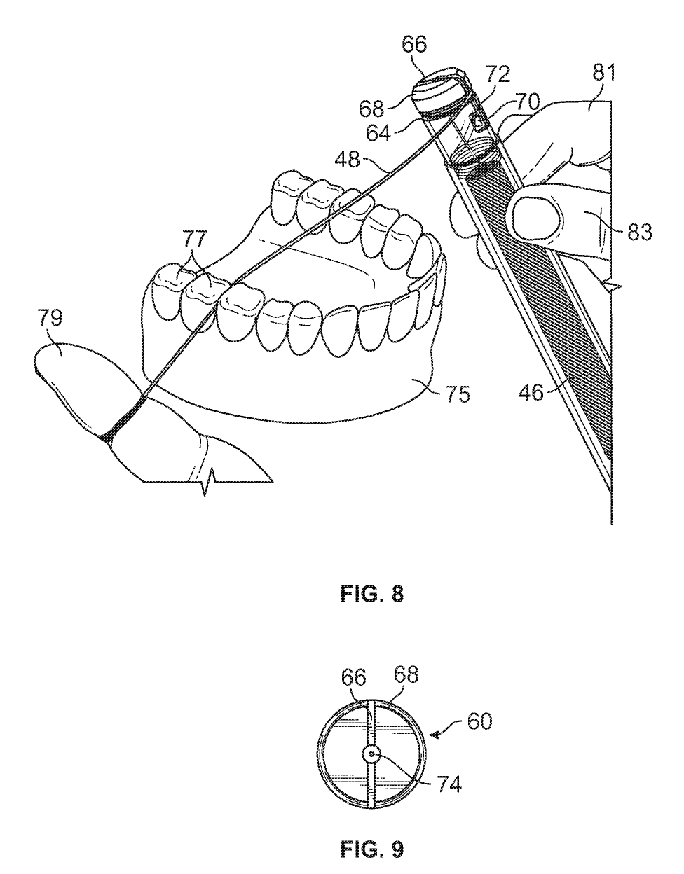

Turning to FIGS. 4-7, the process of creating wound coil of floss 46 is illustrated. As shown in the figures, floss payout end 48 is disposed at one end of a spindle 56. Floss payout end 48 remains stationary throughout the winding process described below. To keep floss payout end 48 from moving, a small notch may be created in spindle 56 into which floss payout end may be lodged and secured. Alternatively, the end of spindle 56 near floss payout end 48 may be slightly sticky such that floss payout end 48 remains secured to spindle 56 during the winding process. Preferably, the first winding of the coil is angled to cover the floss adjacent payout end 48 so as to retain its position as it continues to be wound.

After floss payout end 48 is secured to spindle 56, a floss winding end 50 is wrapped around spindle 56 until floss winding end 50 reaches the end of spindle 56 opposite the end where floss payout end 48 is secured. The floss can be wound around spindle 56 by either holding spindle 56 stationary while winding floss winding end 50 around spindle 56, or more preferably by rotating spindle 56 while moving floss winding end 50. To rotate spindle 56, spindle 56 may be mounted to a rotating fixture that rotates at a speed conducive to winding the floss around spindle 56. To wind the floss while spindle 56 is rotating, floss winding end 50 is held at an angle relative to the longitudinal axis of spindle 56, and as the floss is wound on to spindle 56, floss winding end 50 moves linearly relative to spindle 56 in the direction the floss is being wound. In one preferred embodiment, the angle at which floss winding end 50 is wound is 40-50 degrees relative to the longitudinal axis of spindle 56. In another preferred embodiment, the angle at which floss winding end 50 is wound is 30-60 degrees relative to the longitudinal axis of spindle 56. FIG. 4 shows spaces between the coils of wound coil of floss 46. However, in another embodiment there are no spaces between the coils of wound coil of floss 56 and all the coils of floss touch each other.

After floss winding end 50 reaches the end of spindle 56 opposite the end where floss payout end 48 is secured, the winding direction changes and floss winding end 50 is wound toward floss payout end 48. Floss winding end 50 is again wound at the same preferred angle around spindle 56 as described above, except that it is wound at an angle opposite to the angle of the previous layer of floss. The result of winding in this manner is that, in a preferred embodiment the alternating layers of floss are perpendicular to each other. In another preferred embodiment, the alternating layers of floss are at an angle of 80-100 degrees to each other. In yet another preferred embodiment, the alternating layers of floss are at an angle of 60-120 degrees to each other.

The process of winding floss winding end 50 around spindle 56 continues until wound floss coil 46 is the desired size, and then floss winding end 50 is severed to disconnect wound floss coil 46 from the floss supply. Next, spindle 56 is removed from wound coil of floss 46 by pulling spindle 56 from the center of wound coil of floss 46. Floss payout end 48 extends from the inner diameter of wound coil of floss 46, and floss winding end 50 extends from the outer diameter of wound coil of floss 46. The process of winding wound coil of floss 46 may aid in wound coil of floss 46 maintaining its cylindrical shape even after spindle 56 is removed. In one preferred embodiment, wound coil of floss 46 is made from a waxed floss, and the waxed layers of floss attract each other such that the shape of wound coil of floss 46 is maintained.

Creating wound coil of floss 46 in this manner allows for a large amount of floss to be used in dental hygiene device 10 while still providing a low profile device that fits within a conventional toothbrush holder. In one embodiment, wound coil of floss 46 contains 50-80 yards of floss. In another embodiment, wound coil of floss contains 10-50 yards of floss. In yet another embodiment, wound coil of floss contains 0.5-10 yards of floss.

Floss payout end 48 will be provided to the user, who will pull floss payout end 48 to expose a length of floss for a single use. Various prototypes have shown that pulling floss payout end 48 from the inner diameter of wound coil of floss 46 prevents wound coil of floss 46 from getting tangled and preventing a user from getting floss when he desires. Tangling occurred regularly when attempting to expose floss using floss winding end 50, which is on the outside diameter of wound coil of floss 46. Thus, it is a significant feature of the invention to expose floss from the inside diameter of wound coil of floss 46.

Referring now to FIGS. 8 and 9, a method of using dental hygiene device 10 is illustrated. In operation, a user will use dental hygiene device 10 to brush and floss his teeth. Typically, a user will brush his teeth first and then floss, however some users prefer to floss before brushing. When a user picks up dental hygiene device 10 to brush his teeth, he will notice wound coil of floss 46 through longitudinal container wall 42, which is essentially transparent, and this will remind him to floss his teeth at the time they are brushed.

After the user has finished brushing his teeth, he turns dental hygiene device 10 upside down and holds floss dispenser portion 40 between a user's finger 81 and a user's right thumb 83. The user then grips floss payout end 48 that is protruding from end cap aperture 74, and the user pulls floss payout end 48 until he is satisfied that enough floss is exposed with which he can floss his teeth. Then, the user must secure the proximal end of floss payout end 48 to end cap portion 60 to ensure the floss does not slip while he is using it.

To secure the proximal end of floss payout end 48 to end cap portion 60, the user first guides floss payout end 48 along and within longitudinal groove 66, then around beveled corner 68, until the intersection of longitudinal groove 66 and circumferential groove 64. The user then guides floss payout end 48 around circumferential groove 64 one or more times to secure the proximal end of floss payout end 48 to end cap portion 60 by interference of the covering effect of at least a second or third winding over the first one.

The user then winds the distal end of floss payout end 48 around the user's left index finger 79 to secure the distal end of floss payout end 48 to user's left index finger 79. After securing both the proximal and distal ends of floss payout end 48, the user can pull floss payout 48 end taut by moving the user's left index finger 79 and end cap portion 60 away from each other. When the floss payout end 48 is taut, the user can insert the user's left thumb 79 and end cap portion 60 into the user's mouth 75 to guide floss payout end 48 between teeth 77 to clean in between teeth 77, using the floss in a conventional manner.

Inserting end cap portion 60 into user's mouth 75 may provide for an easier flossing experience because the user does not have to insert fingers on both hands into his mouth to floss. Typically, a user's finger will be larger in diameter than end cap portion 60 and floss dispensing portion 40, so it can become more difficult to floss when using two fingers. By inserting end cap portion 60 into the user's mouth 75 instead of user's finger 81 or user's right thumb 83, it is easier to reach areas of the mouth that would otherwise be difficult when using two fingers. The use of a thinner end cap portion 60 also makes flossing more comfortable and may make flossing more hygienic.

After the user has finished flossing, floss payout end 48 is unwound from user's left index finger 79 and from end cap portion 60. The user then grasps the distal end of floss payout end 48 and guides it to cutter 70. The user pulls floss payout end 48 taut against cutter 70, and floss payout end is severed at cutter 70. After cutting, there is a small amount of floss payout end 48 that protrudes through end cap aperture 74 so the user has access to the new floss payout end 48 and can repeat the process described above the next time he chooses to floss. Additionally, once the floss is cut in the cutter, the floss payout end 48 remains lodged in the cutter 70, between the cutter blade and the plate from which it protrudes, securing the floss payout end 48 to the handle and restraining it so it does not dangle free until next use.

After using dental hygiene device 10 for some time, the user may look through longitudinal container wall 42 and find that he is running out of floss. In one embodiment, dental hygiene device 10 is a disposable device, and the user can purchase another device and use the new device just as he used the old device. In another embodiment, dental hygiene device is a reusable device, and the user can purchase another wound coil of floss 46 and insert it himself into floss dispensing portion 40. After inserting the new wound coil of floss 46 into floss dispensing portion 40, the user guides payout end 48 from the inner diameter of the new wound coil of floss 46 through end cap aperture 74.

To insert a new wound coil of floss 46, the user would first disconnect end cap portion 60 from floss dispensing portion 40 by unscrewing end cap portion from floss dispensing portion. After disposing of the small amount of floss remaining in floss dispensing portion 40, the user would insert the new wound coil of floss 46 into floss dispensing portion 40 such that floss payout end 48 was at the proximal end floss dispensing portion 40. The user would then thread floss payout end 48 through end cap aperture 74, and then secure end cap portion 60 to floss dispensing portion 40 by screwing end cap portion 60 to floss dispensing portion 40. With assembly complete and wound coil of floss 46 in place, the user can use dental hygiene device 10 as he did previously.

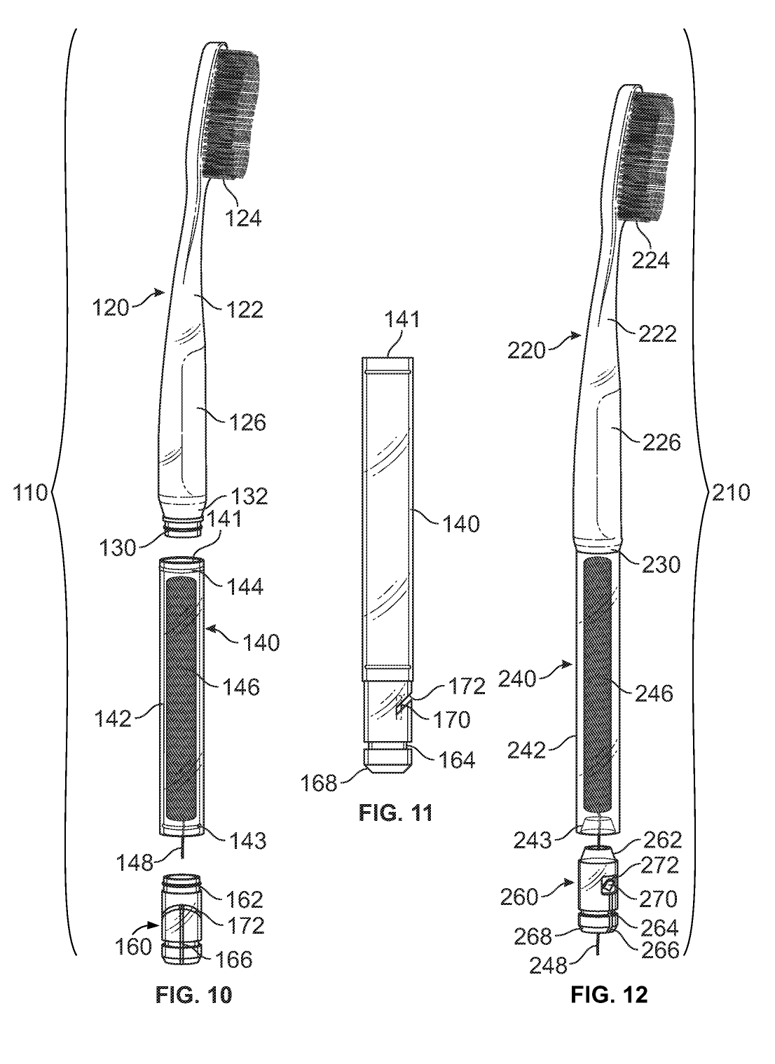

FIGS. 10-12 illustrate other embodiments of the dental hygiene device. In the figures, elements that are identical are provided with identical numbers. Elements having similar structures or functions to those previously described are provided with similar names to those previously used. For example, longitudinal extension 22 of FIG. 1 is similar in structure and function to longitudinal extension 122 of FIG. 10, thus is provided with a similar name.

Referring now to FIGS. 10 and 11, an exploded view of a second embodiment of dental hygiene device 110 is shown. In this embodiment, dental hygiene device 110 includes a brush head portion 120, a floss dispenser portion 140, and an end cap portion 160. Brush head portion 120 further includes a longitudinal extension 122, a brush head 124, a frictional grip protrusion 126, a beveled end 132, and a male snap fit portion 130. Floss dispenser portion 140 further includes a longitudinal container wall 142, a container female snap fit 143, a container female snap fit 144, a wound floss coil 146, and a floss payout end 148. End cap portion 160 further includes a cutter 170, a diagonal slot 172, an end cap male snap fit 162, a circumferential groove 164, a longitudinal groove 166, and a beveled corner 168.

Male snap fit portion 130 and end cap male snap fit 162 are protrusions that mate with container female snap fit 144 and container female snap fit 143, respectively. Male snap fit portion 130 and end cap male snap fit 162 may be fabricated from the same materials as brush head portion 120 and end cap portion 160, respectively, however they may also be fabricated from different materials. For example, male snap fit portion 130 and end cap male snap fit 162 may be plastic, composite, rubber, or another material that provides for a sufficient snap fit.

Container female snap fit 144 and container female snap fit 143 are recesses within longitudinal container wall 142 that are sized to receive male snap fit portion 130 and end cap male snap fit 162, respectively.

To assemble dental hygiene device 110, first brush head portion 120 and floss dispensing portion 140 are connected by pressing the proximal end of brush head portion 120 together with the distal end of floss dispensing portion 140 until male snap fit portion 130 is fully seated within container female snap fit 144. When the parts are fully assembled an audible “click” will be heard. Then, wound floss coil 146 is disposed within floss dispensing portion 140 such that floss payout end 148 extends through the proximal end of floss dispensing portion 140. Floss payout end 148 is then threaded through an end cap aperture (not shown on the figure) similar to end cap aperture 74. Next, floss dispensing portion 140 and end cap portion 160 are connected by pressing the proximal end of floss dispensing portion 140 together with the distal end of end cap portion 160 until male end cap snap fit 162 is fully seated within container female snap fit 143. When the parts are fully assembled an audible “click” will be heard.

Diagonal slot 172 is a recess within the outer wall of end cap portion 160. Cutter 170 is disposed within diagonal slot 172 to prevent a user from accidentally injuring himself when using dental hygiene device 110. Diagonal slot is sized to allow a user to insert floss payout end 148 into diagonal slot 172 after flossing his teeth to sever the floss in preparation for using dental hygiene device 110 again.

Turning to FIG. 12, dental hygiene device 210 includes a brush head portion 220, a floss dispenser portion 240, and an end cap portion 260. Brush head portion 220 further includes a longitudinal extension 222, a brush head 224, a frictional grip protrusion 226, and a tapered brush head edge 230. Floss dispenser portion 240 further includes a longitudinal container wall 242, a wound floss coil 246, and a tapered female opening 243. End cap portion 260 further includes a tapered male end 262, a circumferential groove 264, a longitudinal groove 266, a beveled edge 268, a cutter 270, and an end cap recess 272, within which cutter 270 is disposed.

In this embodiment, brush head portion 220 and floss dispensing portion 240 are connected such that the combination of brush head portion 220 and floss dispensing portion 240 cannot be easily disconnected by a user. Brush head portion 220 and floss dispensing portion 240 may be manufactured as a single part, but they may be manufactured as separate parts and connected via more permanent means than by the threaded or snap-fit connections previously described. Examples of more permanent connections include gluing and sonic welding.

To assemble dental hygiene device 210, wound floss coil 246 is inserted into floss dispensing portion 220 through tapered female opening 243, and payout end 248 is threaded through end cap aperture 274 (not shown on the figure). Then, end cap portion 260 is assembled to floss dispensing portion 240 by pressing the two portions together such that tapered female opening 243 contacts tapered male end 262. Tapered female opening 243 and tapered male end 262 are sized such that when the two elements are pressed together, a secure, press-fit connection is achieved. End cap portion 260 and floss dispensing portion 240 can be separated using sufficient force to dislodge the press fit between tapered female opening 243 and tapered male end 262. A sufficient force to dislodge the two components is a force that is larger than that typically applied to dental hygiene device 210 during normal usage, including tooth brushing and flossing.

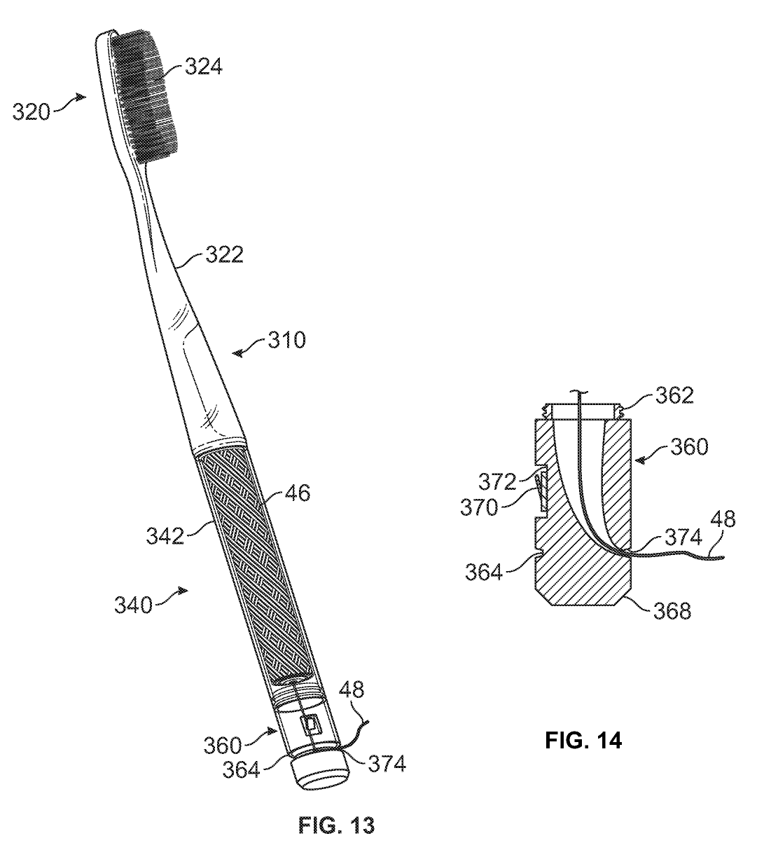

Referring now to FIGS. 13 and 14, dental hygiene device 310 includes a brush head portion 320, a floss dispenser portion 340, and an end cap portion 360. Brush head portion 320 and floss dispenser portion 340 are similar in structure and function to other brush head portions and floss dispenser portions previously discussed. End cap portion 360 differs from previously discussed end cap portions because it includes an end cap side aperture 374 and a circumferential groove 364. End cap side aperture 374 is an opening that extends through circumferential groove 364. The diameter of end cap side aperture 374 is sized to allow floss payout end 48 to extend through end cap side aperture 374. End cap portion 360 also includes end cap male threads 362 to connect to floss dispenser portion 340, though end cap portion 360 may connect to floss dispenser portion 340 in any way previously described, including snap fit or press fit connections.

After the user finishes brushing his or her teeth using dental hygiene device 310, the user turns dental hygiene device 310 upside down and grasps floss payout end 48 that is protruding from end cap side aperture 374. The user then pulls floss payout end 48 until satisfied that enough floss is exposed with which teeth can be flossed. Then, the user must secure the proximal end of floss payout end 48 to end cap portion 360 to ensure the floss does not slip while using it.

To secure the proximal end of floss payout end 48 to end cap portion 360, the user guides floss payout end 48 along and within circumferential groove 364, wrapping the proximal end of floss payout end 48 around circumferential groove 364 one or more times to secure the proximal end of floss payout end 48 to end cap portion 360 by interference of the covering effect of at least a second or third winding over the first one. The user can then floss in the manner described with reference to FIG. 8 above.

After flossing is complete, the user will unwind the proximal end of floss payout end 48 from end cap portion 360. The user then grasps the distal end of floss payout end 48 and guides it to cutter 370. The user pulls floss payout end 48 taut against cutter 370, and floss payout end is severed at cutter 370. After cutting, there is a small amount of floss payout end 48 that protrudes through end cap side aperture 374 so the user has access to the new floss payout end 48 and can repeat the process described above the next time he chooses to floss. Additionally, once the floss is cut in the cutter 370, the floss payout end 48 remains lodged in the cutter 370, between the cutter blade and the plate from which it protrudes, securing the floss payout end 48 to the handle and restraining it so it does not dangle free until next use.

Including end cap side aperture 374 instead of end cap aperture 74 as described in previous embodiments may provide for a more efficient flossing experience for the user by providing floss payout end 48 to the user already within the groove in which the floss will be wound. Thus, the user will not have to focus on properly positioning the floss in the appropriate groove prior to winding the floss to secure it; the user will simply wind the floss around the groove in which the floss is presented.

The invention herein has been described and illustrated with reference to the embodiments of FIGS. 1-14, but it should be understood that the features and operation of the invention as described are susceptible to modification or alteration without departing significantly from the spirit of the invention as disclosed above. For example, the dimensions, size and shape of the various elements may be altered to fit specific applications. Accordingly, the specific embodiments illustrated and described herein are for illustrative purposes only and the invention is not limited except by the following claims.

What is claimed is:

1. A dental hygiene device comprising:
(a) a brush head portion comprising a proximal brush head end and a distal brush head end including a brush head having bristles;
(b) a floss dispenser portion comprising a proximal floss dispenser end and a distal floss dispenser end disposed adjacent to the proximal brush head end;
(c) a hollow section disposed within the floss dispenser portion that extends essentially the entire length of the floss dispenser portion;
(d) a wound coil of floss disposed within the hollow section;
(e) an end cap portion attached to the proximal floss dispenser end, the end cap portion including an end cap shaped, positioned, and oriented to cover the hollow section;
(f) a circumferential groove extending at least partially around the outer diameter of the end cap portion;
(g) a longitudinal groove extending at least partially through a proximal end of the end cap portion; and
(h) an aperture extending through the proximal end of the end cap portion, the aperture being in communication with the hollow section.
wherein the communication between the aperture and the hollow section creates a passage through which a length of dental floss may extend.

2. The dental hygiene device of claim 1, wherein the wound coil of floss includes a floss payout end located on the inside surface of the wound coil of floss and a floss winding end located on the outside surface of the wound coil of floss.

3. The dental hygiene device of claim 2, wherein the aperture is adapted to receive the floss payout end, the floss payout end extending from the hollow section and through the passage.

4. The dental hygiene device of claim 3, wherein the wound coil of floss includes layers of dental floss, the layers of dental floss arranged such that an angle between a first layer of dental floss and a second layer of dental floss is preferably between 80 degrees and 100 degrees, the second layer of dental floss being disposed directly above or below the first layer of dental floss.

5. The dental hygiene device of claim 4, wherein the angle between the first layer of dental floss and the second layer of dental floss is more preferably 90 degrees.

6. The dental hygiene device of claim 1, further comprising a floss cutter disposed on the end cap portion.

7. The dental hygiene device of claim 6, wherein the end cap portion is cylindrical having an outer diameter, and the floss cutter is recessed below the outer diameter of the end cap portion.

8. The dental hygiene device of claim 1, wherein the distal floss dispenser portion is releasably attached to the proximal brush head end.

9. The dental hygiene device of claim 1, wherein the floss dispenser portion is integral with the brush head portion.

10. The dental hygiene device of claim 1, wherein the wound coil of floss preferably includes between 0.5 yards and 80 yards of dental floss.

11. The dental hygiene device of claim 10, wherein the dental floss coil preferably includes between 10 yards and 20 yards of dental floss.

12. A method of providing oral care, comprising:
(a) providing an dental hygiene device, comprising:
(i) a brush head portion comprising a proximal brush end and a distal brush head end including bristles;
(ii) a floss dispenser portion comprising a proximal floss dispenser end and a distal floss dispenser end disposed adjacent to the proximal brush head end;
(iii) a hollow section disposed within the floss dispenser portion that extends the entire length of the floss dispenser portion;
(iv) a wound coil of floss disposed within the hollow section;
(v) an end cap portion attached to the proximal floss dispenser end shaped, positioned, and oriented to cover the hollow section;
(vi) a circumferential groove extending at least partially through the outer diameter of the end cap portion;
(vii) a longitudinal groove extending at least partially through a proximate end of the end cap portion; and
(viii) an aperture extending through the proximal end of the end cap portion;
(b) pulling a floss payout end of the wound coil of floss, the floss payout end extending through the aperture until a length of floss reaches a length suitable to permit access to floss;
(c) securing the floss payout end to the end cap portion by guiding the length of floss proximal to the floss payout end through the longitudinal groove and the circumferential groove to create a secured end of the length of floss;
(d) pulling the floss payout end to create tension in the secured length of floss; and
(e) inserting the secured length of floss between two teeth to clean a space between the two teeth.

13. The method of claim 12, further comprising pulling the secured length of floss against the floss cutter to sever the length of floss after use.

14. The method of claim 12, further comprising wrapping the floss payout end around a finger to secure the floss payout end.

15. The method of claim 14, further comprising inserting the finger and the end cap portion into a mouth.

16. The method of claim 15, further comprising inserting the secured length of floss between two teeth in the mouth to floss in between the two teeth.

17. A dental hygiene device comprising:
(a) a brush head portion comprising a proximal brush head end and a distal brush head end including a brush head having bristles;
(b) a floss dispenser portion comprising a proximal floss dispenser end and a distal floss dispenser end disposed adjacent to the proximal brush head end;
(c) a hollow section disposed within the floss dispenser portion that extends essentially the entire length of the floss dispenser portion;
(d) a wound coil of floss disposed within the hollow section;
(e) an end cap portion attached to the proximal floss dispenser end, the end cap portion including an end cap shaped, positioned, and oriented to cover the hollow section;
(f) a circumferential groove extending at least partially around the outer diameter of the end cap portion; and
(g) an aperture extending through the circumferential groove, the aperture being in communication with the hollow section;
wherein the communication between the aperture and the hollow section creates a passage through which a length of dental floss may extend.
